(19) United States
(12) Patent Application Publication
(10) Pub. No.: US 2003/0025872 A1
(43) Pub. Date: Feb. 6, 2003

(54) Contact lens comprising a turquoise colorant

(76) Inventor: Gerardo J. Ocampo, Bridgeview, IL (US)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 10/169,952

(22) PCT Filed: Jan. 2, 2001
(86) PCT No.: PCT/US01/00068

(51) Int. Cl. G02C 7/04

(52) U.S. Cl. 351/162

(57) ABSTRACT

A colored contact lens includes a pupil section and an iris section surrounding the pupil section wherein the iris section is at least partly covered by a turquoise colorant having a blue component, a green component, a titanium dioxide component, and a violet component. The colored contact lens may also have a hazel colorant and/or a dark colorant. The colored contact lens makes the iris of the wearer of the lens appear to be a striking turquoise color.

### RELATED APPLICATIONS

This application claims the benefit under 35 U.S.C. §119(e) of the filing date of the provisional U.S. patent application having serial No. 60/174,288, filed on Jan. 3, 2000, which is hereby incorporated by reference.

### BACKGROUND OF THE INVENTION

Over the years, many attempts have been made to modify or change the appearance of color of one's eyes using colored contact lenses with varying degrees of success. Attempts to produce an opaque lens with a natural appearance are disclosed in. U.S. Pat. Nos. 3,536,386, (Spivak); 3,679,504 (Wichterle); 3,712,718 (LeGrand), 4,460,523 (Neefe), 4,719,657 (Bawa), 4,744,647, (Meshel et al.), 4,634,449 (Jenkins); European Patent Publication No. 0 309 154 (Allergan) and U.K. Patent Application No. 2 202 540 A (IGEL).

Commercial success was achieved by the colored contact lens described in Knapp (in U.S. Pat. No. 4,582,402), which discloses a contact lens having, in its preferred embodiment, colored, opaque dots. The Knapp lens provides a natural appearance with a lens that is simple and inexpensive to produce, using a simple one-color printed dot pattern. Although, in Knapp, the intermittent pattern of dots does not fully cover the iris, the invention provides a sufficient density of dots that a masking effect gives the appearance of a continuous color when viewed by an ordinary observer. Knapp also discloses that the printing step may be repeated one or more-times using different patterns in different colors, since upon close examination the iris's of many persons are found to contain more than one color.

The printed pattern need not be absolutely uniform, allowing for the change or modification of the appearance of the fine structure of the iris. The one-color Knapp lenses currently achieving commercial success have their dots arranged in an irregular pattern to enhance the structure of the iris. However, neither the Knapp commercial lenses, nor the Knapp patent disclose or suggest a contact lens in which the color and design combine to change a person's eyes to a striking turquoise color.

Other attempts to create a more natural appearing lens include U.S. Pat. No. 5,120,121 to Rawlings, which discloses a cluster of interconnecting lines radiating from the periphery of the pupil portion to the periphery of the iris portion. Further, European Patent No. 0 472 496 A2 shows a contact lens having a pattern of lines that attempts to replicate the lines found in the iris.

Although many attempts have been made to create colored contact lenses that change or modify the appearance of color of the iris, none of the colored contact lenses have addressed changing or modifying the appearance of the contact wearer's eyes so that they appear to be a natural, striking, turquoise color.

### SUMMARY OF THE INVENTION

In one aspect of the invention, a colored contact lens is provided. The contact lens comprises a pupil section and an iris section surrounding the pupil section wherein the iris section is at least partly covered by a turquoise colorant having a blue component, a green component, a titanium dioxide component, and a violet component.

In another aspect of the invention, a contact lens is provided that is worn by a person to change the appearance of a human iris to a turquoise color. The contact lens comprises a non-opaque pupil section, an iris section surrounding said pupil section, and a colored, opaque intermittent pattern over said iris section that leaves a substantial portion of the pattern non-opaque, said pattern covering at least about 25% of the area of said iris section, the elements of said pattern being indiscernible to the ordinary viewer, said pattern being made up of a turquoise colorant, a hazel colorant, and a dark colorant.

In still another aspect of the invention, a contact lens comprises a non-opaque pupil section, an iris section surrounding said pupil section, and at least two colored, opaque intermittent patterns over said iris section that leaves a substantial portion of the pattern non-opaque, said patterns covering at least about 25% of the area of said iris section, wherein the elements of a first pattern comprise turquoise colorant and the elements of a second pattern comprise hazel colorant.

The term “non-opaque” as used herein is intended to describe a part of the lens that is uncolored or colored with translucent coloring.

The term “ordinary viewer” is intended to mean a person having normal 20-20 vision standing about 5 feet from a person wearing the lenses of this invention.

### BRIEF DESCRIPTION OF THE DRAWINGS

FIG. 1 illustrates a contact lens having a pupil section and an iris section.

FIG. 2 illustrates an outermost starburst pattern for use on a contact lens.

FIG. 3 illustrates an outer starburst pattern for use on a contact lens.

FIG. 4 illustrates an inner starburst pattern for use on a contact lens.

FIG. 5 illustrates a graph of reflectance versus wavelength of the turquoise colorant on a contact lens.

FIG. 6 illustrates a graph of reflectance versus wavelength of a hazel colorant on a contact lens.

FIG. 7 illustrates a graph of reflectance versus wavelength of a black colorant on a contact lens.

### DETAILED DESCRIPTION OF THE DRAWINGS AND THE PREFERRED EMBODIMENTS OF THE INVENTION

FIG. 1 shows a contact lens 10. It has a non-opaque pupil section 20 in the center of the lens, and an annular iris section 22 surrounding the pupil section. For hydrophilic lenses a peripheral section surrounds iris section 22. A colored, opaque, intermittent pattern is located over the iris section 22, as shown in FIG. 1. The pattern leaves a substantial portion of the iris section within the interstices of the pattern non-opaque. The non-opaque areas of the iris section 22 appear white in FIG. 1.

The elements of the pattern are preferably dots, and especially preferred are dots, some of which run together, as shown in FIG. 1. Certain portions of the iris section 22 are less densely covered with dots than other portions.

The opaque pattern or patterns can be made up of dots having regular or irregular, uniform or non-uniform shapes, for example, round, square, hexagonal, elongated, or other dot shapes. Further, the elements of the pattern may have a shape other than dots, so long as the elements are indiscernible to the ordinary viewer, cover between 10 and 30 percent, preferably about 20 or 25 percent of the iris, and leave a substantial portion of the iris section within the interstices of the pattern non-opaque. The patterns that make up the portions of the iris can be islands of color or worms, corkscrews, starbursts, spokes, spikes, striations, radial stripes, zig-zags and streaks. In certain cases, a single color background is used to complement the multi-pattern design. These patterns blend with each other to provide a colored contact lens that enhances the structure of the iris of a person wearing the lens.

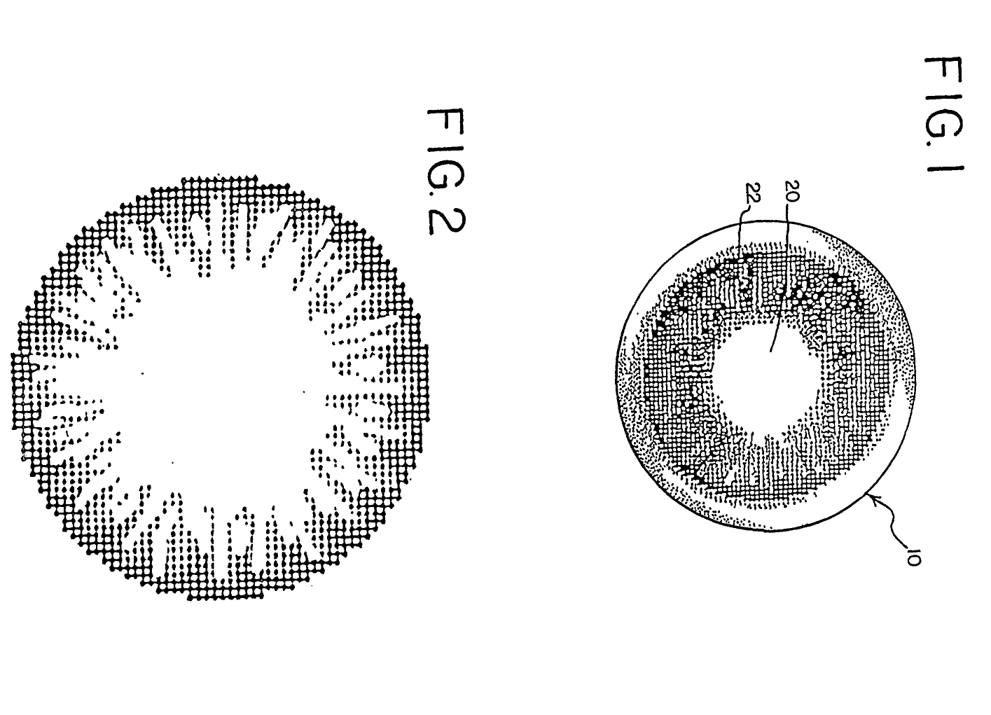

One embodiment of this invention includes a multiple color pattern that greatly improves the natural appearance of the wearer's iris, even over that of one and two color lenses. To produce this embodiment, three (or more) colored patterns are printed in three or more portions. A first portion of the elements are a first shade and generally have a greatest concentration of dots or other elements located generally on the outside of, but within, the iris section, i.e. at or near the outer perimeter of the annular iris section. This section may be shaped as the outermost starburst. A preferable first outside portion pattern or outermost starburst is shown in FIG. 2. Black, or some other dark color such as gray, dark-brown or dark blue, is most often used as the color of the outermost starburst.

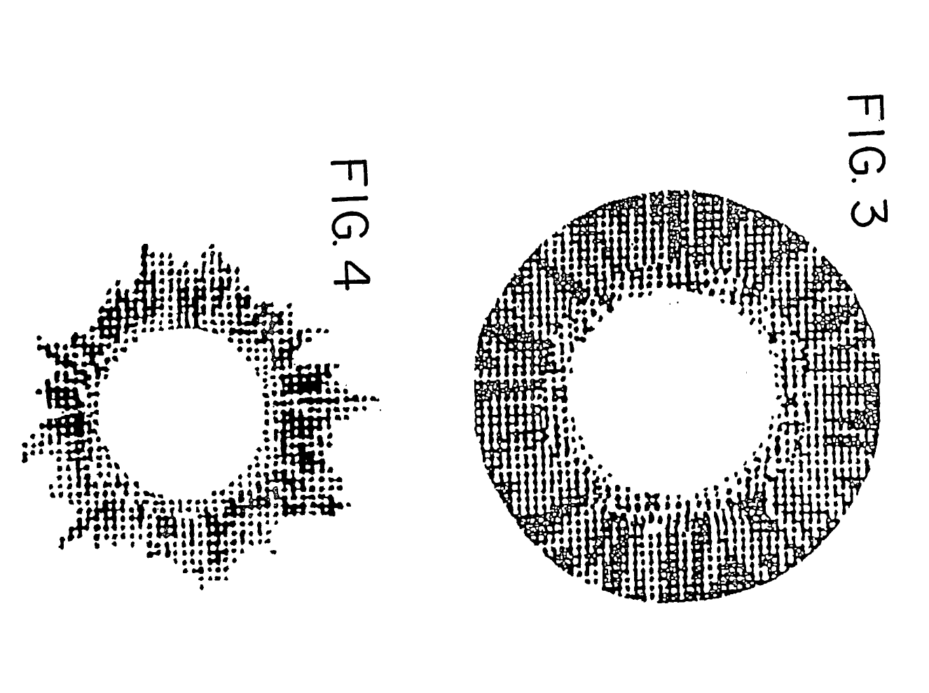

A second portion (the outer starburst) of the elements are a second shade, which is different from the first shade, and has elements with a greatest concentration located generally on the inside of the outermost starburst, and generally, although not always, surrounded by the outermost starburst portion. A preferable second portion or outer starburst appears in FIG. 3. The outer starburst can be many colors, for example, blue, gray, brown, light blue, turquoise, violet, blue-violet, aqua, yellow or green. Most preferably, the outer starburst is turquoise. When the outer starburst is not turquoise, the turquoise colorant may be applied in a different pattern.

A third portion (the inner starburst) of the elements are of a third shade, which is different from the second shade and either the same or different from the first shade. This third portion has a greatest concentration of elements located generally, but not always, on the inside of the other two portions. Generally, the greatest concentration of elements of the third portion is surrounded by the concentration of elements of the other two portions. A preferable third inside portion pattern, preferably an inner starburst, appears in FIG. 4. The preferred color for the inner starburst is hazel, but other colors to be used include yellow, yellow-green, brown, yellow-brown, gold and orange. FIG. 1, the preferred embodiment of the present invention, shows a combination of FIGS. 2, 3 and 4.

In the preferred embodiment, a first uneven border differentiates the outermost starburst and the outer starburst portions of the pattern elements, however, the elements of the outermost and outer starbursts overlap, mix and blend together, either in actuality or merely in perception, to create the desired effect. A second uneven border differentiates the outer starburst and the inner starburst portions of the pattern, however, again the elements of the outer and inner starbursts overlap, mix and blend together, either in actuality or in perception. If the patterns of FIGS. 2, 3 and 4 are merged to form a three color lens, the uneven edge of the pattern shown in FIG. 2 will merge and overlap with the pattern shown in FIG. 3 to form the first uneven border between the outermost and outer starbursts. Further, the uneven edge of the pattern shown in FIG. 4 will merge and overlap with the pattern shown in FIG. 3 to form the second uneven border between the outer and inner starbursts.

In certain patterns, the outer starburst may contain a pattern that extends further toward the periphery of the lens than the pattern of the outermost starburst. In other patterns, the outer starburst may contain a pattern that extends further toward the pupil section of the lens than the pattern of the inner starburst.

Alternative embodiments of the present invention include minimum and maximum distances of the uneven borders from the outer perimeter of the iris section. For example in one alternative embodiment, the minimum distance of the first uneven border from the outer perimeter of the iris section is from about 5% to about 60% of the radial width of the iris section, and the maximum distance of the uneven border from the outer perimeter of the iris section is from about 25% to about 95% of the radial width of the iris section, and the minimum distance of the second uneven border from the outer perimeter of the iris section is from about 15% to about 75% of the radial width of the iris section, and the maximum distance of the uneven border from the outer perimeter of the iris section is from about 50% to about 95% of the radial width of the iris section.

In another embodiment, the minimum distance of the first uneven border from the outer perimeter of the iris section is from about 15% to about 50% of the radial width of the iris section, and the maximum distance of the uneven border from the outer perimeter of the iris section is from about 45% to about 95% of the radial width of the iris section, and the minimum distance of the second uneven border from the outer perimeter of the iris section is from about 15% to about 65% of the radial width of the iris section, and the maximum distance of the uneven border from the outer perimeter of the iris section is from about 60% to about 95% of the radial width of the iris section.

In another embodiment, the minimum distance of the first uneven border from the outer perimeter of the iris section is from about 15% to about 50% of the radial width of the iris section, and the maximum distance of the uneven border from the outer perimeter of the iris section is from about 45% to about 95% of the radial width of the iris section, and the minimum distance of the second uneven border from the outer perimeter of the iris section is from about 15% to about 65% of the radial width of the iris section, and the maximum distance of the uneven border from the outer perimeter of the iris section is from about 60% to about 95% of the radial width of the iris section.

In yet another alternative embodiment, the outer starburst pattern may extend to the periphery of the iris section of the contact lens, such that some elements that make up the outer starburst are outside of all of the elements that make up the outermost starburst pattern, and/or the elements that make up the outer starburst pattern extend closer to the pupil section such that some of those elements are inside all of the elements of the inner starburst pattern.

In yet another alternative embodiment, the inner starburst pattern creates an interdigitation configuration with either the outermost starburst pattern or the outer starburst pattern or both patterns. Further, the outermost starburst pattern may create an interdigitation configuration with the outer starburst pattern. In an interdigitation configuration, one pattern intersects another similar to the fingers on one hand placed between the fingers on the other hand in a planar fashion.

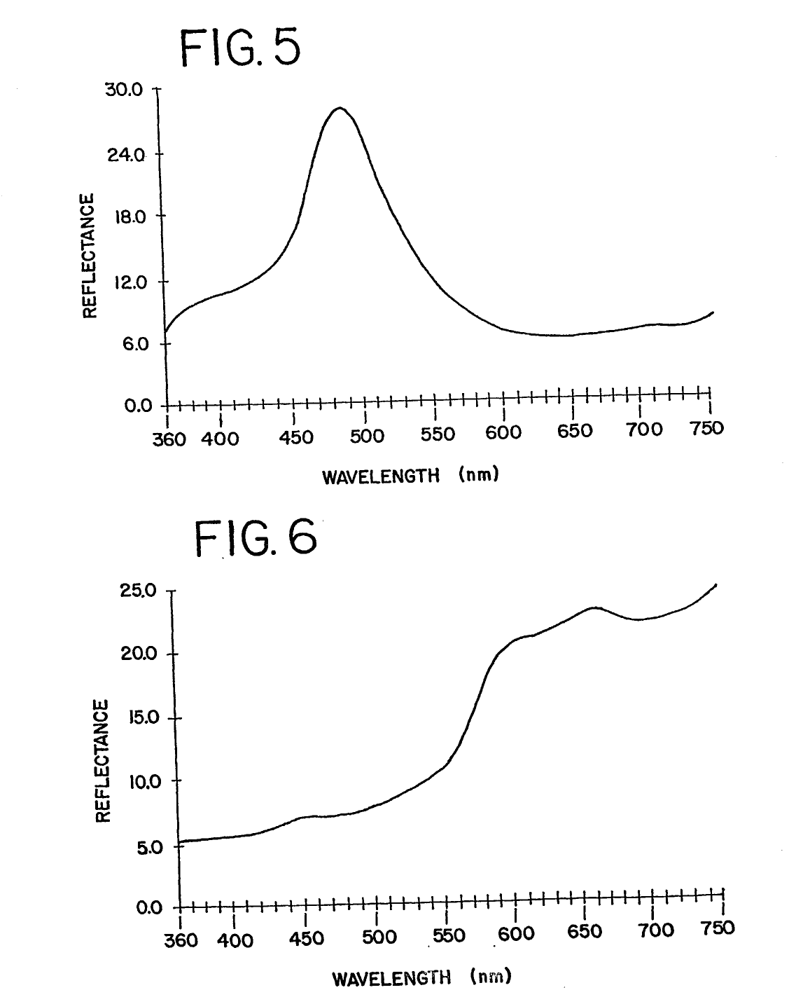

Referring to FIG. 5, a graph of reflectance versus wavelength of a preferred turquoise colorant on a contact lens is shown. The graph shows that a contact lens having the turquoise colorant on it, when measured spectrophotometrically, comprises a non-standard reflectance between about 430 and about 600 nm, in which the reflectance rises to about 30 reflective units at a wavelength of approximately 480 nm. Between 600 nm and 750 nm, the reflectance is about 7 reflective units.

The turquoise colorant that produces the above reflectance data is preferably an ink paste containing the following ingredients:

| | INK PASTE COLOR | | |
|---|---|---|---|
| | TURQUOISE | | |
| | Weight | Target | Target |
| Ingredient | Percent | Weight | Weight |
| Ethyl Lactate | 30.00 | 180.00 | 900.00 |
| Binder Soln | 58.16 | 348.96 | 1744.80 |
| PCN Blue | 0.63 | 3.78 | 18.90 |
| PCN Green | 2.25 | 13.50 | 67.50 |
| TiO₂ | 8.88 | 53.28 | 266.40 |
| Carbazole Violet | 0.08 | 0.48 | 2.40 |
| Total Wt. (g) | | 600 | 3000 |

A contact lens having only the above turquoise colorant thereon has been measured under the CIE Color Notation System. The contact lens has the following measurements: a L* of about 43.3, an a* of about −24.9, and a b* of about −9.8.

The CIE Color Notation System, a way in which to measure color, is a calorimetric specification system based on stimulus-response characteristics adopted by the CIE in 1931. The current recommendations for the system may be obtained from the official publication, CIE Publication No.15 (E-1.3.1) 1971, Colorimetry Official Recommendation of the International Commission on Illumination available from the National Bureau of Standards, Wash., D.C. 20234.

The CIE Standard Observer is the observer data adopted by the CIE to represent the response of the average human eye, when light-adapted, to an equal energy spectrum. Unless otherwise specified, the term applies to the data adopted in 1931 for a 2 degree field of vision. The data adopted in 1964, sometimes called the 1964 observer, were obtained for a 10 degree, annular field which excludes the 2 degree field of the 1931 observer functions.

The colorant in the present invention can be measured spectrophotometrically. In accordance with the CIE method of measurement, and in particular the CIE 1976 Color Difference Equation:

$$Δ {E}_{C I E} ( {L}^{*} , {a}^{*} , {b}^{*} = {\vert {( Δ {L}^{*} )}^{2} + {( Δ {a}^{*} )}^{2} + {( Δ {b}^{*} )}^{2} \vert}^{1 / 2} \\ \begin{matrix}w h e r e {L}^{*} = 25 {( \frac{100 Y}{{Y}_{o}} )}^{1 / 3} - 16 & ( 1 < Y < 100 )\end{matrix} \\ {a}^{*} = 500 {\vert ( \frac{X}{{X}_{o}} ) \vert}^{1 / 3} - {( \frac{Y}{{Y}_{o}} )}^{1 / 3} \vert \\ {b}^{*} = 200 {\vert ( \frac{Y}{{Y}_{o}} ) \vert}^{1 / 3} - {( \frac{Z}{{Z}_{o}} )}^{1 / 3} \vert P$$

X, Y, and Z are the tristimulus values of the sample, Xo, Yo, and Zo define the color of the nominally white object color stimulus (the illuminant); ΔL=L* for the sample, −L* for the standard; Δa=a* for the sample, −a* for the standard; −b=b* for the sample, −b* for the standard.

Two panels containing the colorant of the present invention were measured spectrophotometrically in accordance with the CIE Color Notation System, using a standard of olive-gold #1133-67. The olive-gold standard is 52.160 for L*, −3.384 for a*, and 32.585 for b*.L* for panel #1 was measured to be 52.142, while a* and b* measured −3.365 and 32.564 respectively. AL measured at −0.018, Δa* measured at 0.019, Δb* measured at −0.021, and ΔE was 0.034. On the panel #2, L* was measured to be 52.018, while a* and b* measured −3.265 and 32.592 respectively. ΔL measured at −0.142, Δa* measured at 0.118, Δb* measured at 0.006, and ΔE was 0.185.

In a preferred embodiment, the turquoise colorant is patterned as an outer starburst on a contact lens. The contact lens may have another colorant that is patterned as an inner starbust. Preferably, the inner starburst is hazel. More preferably, the hazel colorant is an ink paste having the following ingredients:

| | INK PASTE COLOR | | |
|---|---|---|---|
| | HAZEL | | |
| | Weight | Target | Target |
| Ingredient | Percent | Weight | Weight |
| Ethyl Lactate | 30.00 | 180.00 | 900.00 |
| Binder Soln | 63.49 | 380.94 | 1904.70 |
| PCN Blue | 0.06 | 0.36 | 1.80 |
| TiO₂ | 0.61 | 3.65 | 18.3 |
| IO Red | 1.54 | 9.25 | 46.20 |
| IO Yellow | 4.30 | 25.80 | 129.00 |
| Total Wt. (g) | | 651 | 3000 |

Referring to FIG. 6, a graph of reflectance versus wavelength of the hazel colorant, and no other colorants, on a contact lens is shown. The graph shows that a contact lens having the hazel colorant on it, when measured spectrophotometrically between 360 nm and 550 nm rises gradually from about 5 reflective units to about 10 reflective units. From about 550 nm to about 590 nm, the reflectance rises rapidly to about 21 reflective units.

Between 590 nm and 750 nm, the reflectance is generally higher than 21 reflective units and lower than about 25 reflective units.

A contact lens having only the above hazel colorant thereon has been measured under the CIE Color Notation System. The contact lens has the following measurements: a L* of about 42.3, an a* of about 15.8, and a b* of about 18.9.

A preferred contact lens may have still another colorant, preferably patterned as an outermost starburst. Preferably, the colorant is dark. More preferably, the colorant is a black ink paste comprising IO black, such as the ink paste shown in the following table:

| | INK PASTE COLOR | | |
|---|---|---|---|
| | BLACK | | |
| | Weight | Target | Target |
| Ingredient | Percent | Weight | Weight |
| Ethyl Lactate | 23.98 | 156.11 | 719.40 |
| Binder Soln | 64.04 | 416.90 | 1921.20 |
| TiO₂ | 11.98 | 77.99 | 359.4 |
| Total Wt. (g) | | 651 | 3000 |

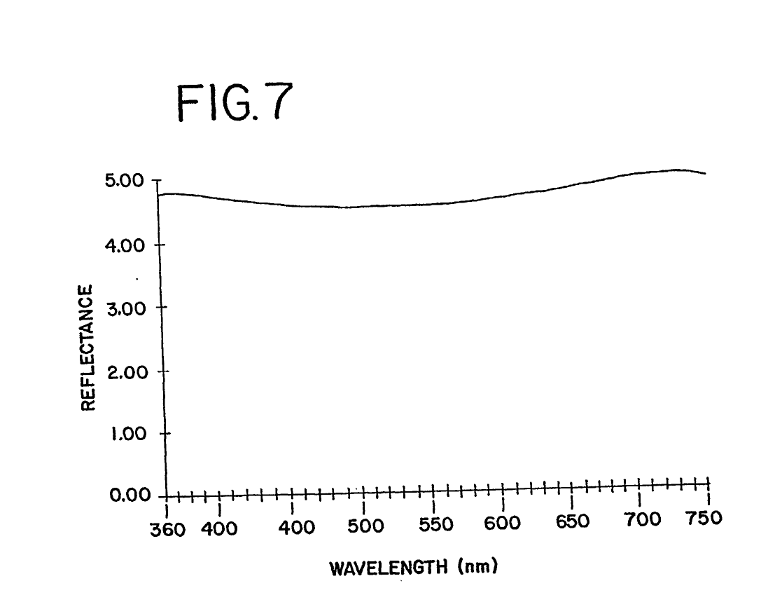

Referring to FIG. 7, a graph of reflectance versus wavelength of the black colorant, and no other colorants, on a contact lens is shown. The graph shows that a contact lens having the black colorant on it, when measured spectrophotometrically, comprises a substantially straight line at about reflective units across all measured wavelengths.

A contact lens having only the above black colorant thereon has been measured under the CIE Color Notation System. The contact lens has the following measurements: a L* of about 25.5, an a* of about 0.54, and a b* of about −0.15.

Producing the opaque portions of the iris section of the contact lenses is preferably accomplished by printing the lens three times using the known printing process of Knapp's U.S. Pat. No. 4,582,402, incorporated herein by reference, and the known printing process of Rawlings' U.S. Pat. Nos. 5,034,166 and 5,116,112, incorporated herein by reference. Generally, a plate or cliché having depressions in the desired pattern is smeared with ink of the desired shade. Excess ink is removed by scraping the surface of the plate with a doctor blade leaving the depression filled with ink.

A silicon rubber pad is pressed against the plate to pick up the ink from the depressions and then is pressed against a surface of the lens to transfer the pattern to the lens. The printed pattern is then cured to render it unremovable from the lens. Of course, either the anterior or posterior surfaces of the lens may be printed, but printing the anterior surface is presently preferred.

The preferred lenses and ink ingredients used to practice this invention are known and described in Loshaek's U.S. Pat. No. 4,668,240, incorporated herein by reference. The specific ingredients and target weights are described in detail below. Very briefly, a lens constructured of polymer having —COOH, —OH, or —NH² groups is printed with ink containing binding polymer having the same functional groups, opaque coloring substance, and a diisocyanate compound. First a solution of binding polymer and solvent is prepared and this solution is mixed with paste containing the coloring substance to form an ink. The preferred binding polymer solutions have a viscosity of about 35,000 CPS for blue, gray, brown and black, and 50,000 CPS for green. The opaque ink is printed and cured on the lens surface.

Ink pastes and pigments which can be used in the present invention can be made in a number of different ways using the ingredients and percentages (by weight) as described below in the ink color charts. For example, a hazel ink paste can be made using 64.59 percent binder solution (by weight), 30.00 percent ethyl lactate, 0.61 percent titanium dioxide, 0.06 percent PCN blue, 4.30 percent iron oxide yellow, and 1.54 percent iron oxide red. Although these colors are used for the preferred embodiments, other colors or variations of the weight percentage of ingredients may be used. The charts below are merely a representative example of the possible inks and pigment levels, and is not a complete list. One having ordinary skill in the art could develop other inks and pigment levels that would provide an enhancing effect to the iris of a person wearing the contact lens.

Of course, alternative ways to form colored opaque elements of the lens may be used. For example, selected portions of the iris section of a wetted hydrophilic lens may be impregnated with a solution of a first substance, such as barium chloride. Then the lens may be immersed in a solution of a second substance, such as sulfuric acid, that forms an opaque, water-insoluble precipitate with the first substance, for example barium sulfate. Thus an opaque precipitate forms within the lens in a predetermined pattern in the iris section.

Next, all or at least part of the iris section is colored with an opaque colorant in a pattern. If the entire iris is colored with translucent tint, then the interstices within the pattern will be translucently colored, but still non-opaque and in accordance with the preferred embodiment of the present invention. Optionally, the pupil section of the lens may be colored by a non-opaque tint, because such tint is not visible when the lens is against the dark pupil present in the eye of the wearer. Other alternative opaquing methods include use of a laser as described in U.S. Pat. No. 4,744,647 and finely ground particles as described in U.S. Pat. No. 4,460,523.

The process of the present invention for making colored contact lenses is as follows. A transparent contact lens comprising at least a pupil section and an iris section surrounding the pupil section is provided. If the lens is constructed of a hydrophilic material, it also has a peripheral section surrounding the iris section. For hydrophilic material, the steps described below are performed with the material in an unhydrated state. Preferred hydrophilic materials are disclosed by Loshaek in U.S. Pat. No. 4,405,773, incorporated herein by reference.

The colored pattern may be deposited onto the iris section of the lens in any manner. The currently preferred method is by offset pad printing, described below in some detail.

A plate as (not shown) is prepared having flat surface and circular depressions corresponding to the desired dot pattern. To make the pattern shown in FIGS. 2, 3 and 4, each depression should have a diameter of approximately 0.1 mm, and a depth of approximately 0.013 mm. The depressions are arranged to cover an annular shape corresponding to that of the iris section of the lens.

The plate may be made by a technique that is well known for making integrated analog or digital circuits. First a pattern about 20 times as large as the desired pattern is prepared. Next the pattern is reduced using well-known photographic techniques to a pattern of the exact desired size having the portion to be colored darker than the remaining area. A flat surface is covered by a photo resist material that becomes water insoluble when exposed to light. The photo resist material is covered with the pattern and exposed to light. The portion of the photo resist pattern is removed by washing with water and the resulting plate is etched to the required depth. Then the remainder of the photo resist material is mechanically removed.

Colorant, comprising a pigment and binder or carrier for the pigment, is deposited on the flat surface of the plate and scraped across the pattern with a doctor blade. This causes depressions to be filled with ink while removing excess ink from the flat surface. The colorant may be more or less opaque depending on the degree of color change desired. The opacity may be varied by modifying the proportion of pigment to binder in the colorant. It will be recognized that a desired affect may be obtained using a highly opaque colorant or by having a somewhat less opaque colorant and covering a greater portion of the iris section surface.

A pad made of silicon rubber, impregnated with silicon oil for easy release, is pressed against the pattern, removing ink from depressions. The ink on the pad is allowed to dry slightly to improve tackiness, then pressed against the front surface of the contact lens, depositing the ink in the desired pattern over the iris section. Of course the pad must have enough flexibility to deform to fit over the convex front surface of the lens. For a more natural effect, the printing step may be repeated one or more times using different patterns in different colors, since upon close examination, the iris's of many persons are found to contain more than one color. The printed pattern need not be absolutely uniform, allowing for enhancement of the fine structure of the iris.

Next the deposited pattern is treated to render it resistant to removal from the lens under exposure to the ocular fluids that the lens will encounter when placed in the eye. The exact method of preventing removal depends on the material of construction of the lens and the pattern. Mere air drying or heating the lens may suffice. For hydrophilic lenses, the techniques for coating the opaque pattern described in Wichterle, U.S. Pat. No. 3,679,504 (incorporated herein by reference), may be used.

The method for manufacturing a preferred colored contact lens generally includes the steps of applying three portions of colorant to the surface of a transparent contact lens and rendering the colorant resistant to removal from ocular fluids. The printed contact lens will have a non-opaque pupil section and an iris section surrounding said pupil section with the three portions of colorant. The first portion of colorant, or outermost starburst, is of a first shade, the second portion of colorant, the outer starburst, is a second shade which is different than the first shade, and the third portion of the colorant, or the inner starburst, is a third shade which is different than the second shade and may or may not be the same as the first shade.

The outermost starburst will be located such that the greatest concentration of elements of the outermost starburst are located generally on the outside of, but still within, the iris section, and generally on the outside of the concentration of elements of the outer starburst, the greatest concentration of elements of the outer starburst will be located generally on the outside of the greatest concentration of elements of the inner starburst, and a first uneven border will differentiate the outermost starburst and the outer starburst although the outermost starburst and the outer starburst potions will overlap, a second uneven border will differentiate the outer starburst and the inner starburst although the outer and inner starbursts will overlap. Thus, a lens capable of changing the apparent color of the iris of a person wearing the lens and imparting a very natural turquoise appearance will be provided.

The steps used to deposit the intermittent pattern on the lens surface include using a first plate having depressions corresponding to the first portion or outermost starburst and filling the depressions with colorant of the first shade, preferably black. The next step is pressing a first flexible pad against the first plate and subsequently pressing the first flexible pad against the surface of the lens (either side) thereby printing the first portion of the elements.

The next step involves using a second plate having depressions corresponding to the second portion or outer starburst and filling in the depressions with colorant of the second shade which is different from the first shade, preferably turquoise. The next step involves pressing the second flexible pad against a second plate and pressing the second flexible pad against the surface of the lens (either the same or the opposite surface) thereby printing the second portion of the elements.

The final step involves using a third plate having depressions corresponding to the third portion or inner starburst and filling the depressions with colorant of the third shade which is different from the second shade and is either the same or different from the first shade, preferably hazel. This is carried out by pressing a third flexible pad against the third plate and pressing the third flexible pad against said surface of the lens (either side) thereby printing the third portion of the elements. The resultant lens, when worn, makes the iris of the wearer appear to be a striking turquoise color.

Although the steps listed above place an order to the printing of the portions on the lens, the order of printing is not important to the present invention and any other order of printing would be covered by the present invention. Further, the process described above may include the maximum and minimum distances, creating the uneven borders, previously listed in the alternative embodiments.

An alternative embodiment for printing the different layers on the iris section of the contact lens provides for ink-jet printing instead of pad printing of each layer. Ink-jet printing is accomplished without the need of pads or plates and can be administered at a higher resolution than pad printing, thereby providing for greater detail of each colored layer and a more natural final pattern on the iris section of the contact lens.

Using ink-jet printing also reduces the number of devices that make contact either with the contact lens or with other devices. For example, a silicon pad must make contact with a plate or cliche initially and then with the contact lens itself. Contact between the parts tends to wear down the parts, which will then require replacements. During the ink-jet process, the micro-nozzles do not physically make contact with the contact lens, nor with any other device. The chance of the micro-nozzle wearing out is thereby reduced.

Further, the ink-jet printer is electronically controlled such that changing from one color layer to a different color layer can be done easily, by computer control. Thus, once a multiple layer contact lens design is determined and separated into its multiple colored layers, each layer can be applied to the colored contact lens using an ink-jet process, thereby creating a colored contact lens capable of changing the apparent color of the wearer's iris to turquoise.

It can be seen that certain embodiments of the present invention provide a contact lens capable of changing or modifying the appearance of the color of the iris to a striking turquoise color, while allowing visualization of the fine structure thereof and providing a natural appearance. Various changes may be made in the function and arrangement of parts: equivalent means may be substituted for those illustrated and described; and certain features may be used independently from others without departing from the spirit and scope of the invention as defined in the following claims.

1. A colored contact lens comprising a pupil section and an iris section surrounding the pupil section wherein the iris section is at least partly covered by a turquoise colorant having a blue component, a green component, a titanium dioxide component, and a violet component.

2. The contact lens of claim 1 wherein the blue component comprises PCN blue.

3. The contact lens of claim 1 wherein the green component comprises PCN green.

4. The contact lens of claim 1 wherein the violet component comprises carbazole violet.

5. The contact lens of claim 1 wherein the turquoise colorant is an ink paste comprising about 0.63% PCN blue by weight, 2.25% PCN green by weight, 8.88% titanium dioxide by weight, and 0.08% carbazole violet by weight.

6. The colored contact lens of claim 5 wherein the turquoise colorant has the property such that if it is the only colorant on the contact lens, the lens when measured under the CIE Color Notation System comprises a L* of about 43.3, an a* of about −24.9, and a b* of about −9.8.

7. The colored contact lens of claim 5 wherein the turquoise colorant has the property such that if it is the only colorant on the contact lens, the lens when measured spectrophotometrically comprises a non-standard reflectance between about 430 and about 600 nm, in which the reflectance rises to about 30 reflective units at a wavelength of approximately 480 nm.

8. A colored contact lens intended to be worn by a person to change the appearance of a human iris to a turquoise color, the contact lens comprising a non-opaque pupil section, an iris section surrounding said pupil section, and a colored, opaque intermittent pattern over said iris section that leaves a substantial portion of the pattern non-opaque, said pattern covering at least about 25% of the area of said iris section, the elements of said pattern being indiscernible to the ordinary viewer, said pattern being made up of a turquoise colorant, a hazel colorant, and a dark colorant.

9. The colored contact lens of claim 8 wherein the turquoise colorant comprises PCN blue, PCN green, titanium dioxide, and violet.

10. The colored contact lens of claim 8 wherein the turquoise colorant is applied in pattern elements that are collectively shaped as an outer starburst.

11. The colored contact lens of claim 8 wherein the hazel colorant comprises PCN blue, titanium dioxide, IO red, and IO yellow.

12. The colored contact lens of claim 8 wherein the hazel colorant is applied in pattern elements that are collectively shaped as an inner starburst.

13. The colored contact lens of claim 8 wherein the dark colorant is a black colorant.

14. The colored contact lens of claim 8 wherein the dark colorant is applied in pattern elements that are collectively shaped as an outermost starburst.

15. A colored contact lens comprising a non-opaque pupil section, an iris section surrounding said pupil section, and at least two colored, opaque intermittent patterns over said iris section that leaves a substantial portion of the pattern non-opaque, said pattern covering at least about 25% of the area of said iris section, wherein the elements of a first pattern comprise turquoise colorant and the elements of a second pattern comprise hazel colorant.

16. The contact lens of claim 15 wherein the turquoise colorant is applied in pattern elements that are collectively shaped as an outer starburst

17. The contact lens of claim 15 wherein the hazel colorant is applied in pattern elements that are collectively shaped as an inner starburst.

18. The contact lens of claim 15 having a third pattern, wherein the elements of the third pattern are dark colorant.

19. The contact lens of claim 18 wherein the dark colorant is black.

20. The contact lens of claim 19 wherein the black colorant is applied in pattern elements that are collectively shaped as an outermost starburst.
